(19) United States
(12) Patent Application Publication
(10) Pub. No.: US 2010/0094698 A1
(43) Pub. Date: Apr. 15, 2010

(54) METHOD OF CONDUCTING A TRANSACTION THAT RESULTS IN CUSTOMER REWARDS

(75) Inventor: Patricia Cawley, Wexford, PA (US)

Correspondence Address: BARLOW, JOSEPHS & HOLMES, LTD., 101 DYER STREET, 5TH FLOOR, PROVIDENCE, RI, 02903, US

(73) Assignee: CITIZENS FINANCIAL GROUP, INC., Providence, RI (US)

(21) Appl. No.: 12/576,746

(22) Filed: Oct. 9, 2009

Related U.S. Application Data
(60) Provisional application No. 61/103,980, filed on Oct. 9, 2008.

(51) Int. Cl. G06Q 30/00; G06Q 40/00; G06F 17/00

(52) U.S. Cl. 705/14.17; 235/380; 235/375

(57) ABSTRACT

A general purpose transaction card is provided that offers an attractive incentive to customers to encourage the use of a general purpose transaction card. The general purpose transaction card is offered in connection with a co-branded loyalty program whereby a percentage of a total purchase made at one vendor is deposited into an account maintained at another vendor. More specifically, in a preferred embodiment a grocery vendor deposits a percentage of a customer's total grocery purchase into a savings account held by that customer at a bank service provider. By offering a transaction method in accordance with the teachings of the present invention both of the vendors gain in the number of joint customers while deepening the relationship those customers have with both vendors.

### CROSS-REFERENCE TO RELATED APPLICATIONS

This application is related to and claims priority from earlier filed U.S. Provisional Patent Application No. 61/103,980, filed Oct. 9, 2008.

### BACKGROUND OF THE INVENTION

The present invention relates generally to a method for promoting customer purchases at a first vendor through incentive rewards deposited with a second vendor. More specifically, the present invention relates to method of conducting a transaction through one vendor that results in rewards accruing at an account maintained at a second vendor thereby promoting the goods and services of both vendors simultaneously.

Generally over the past few years customer loyalty programs, which are offered by various vendors to their consumers, have grown exponentially. In this regard, while there are a variety of different structural models on which such loyalty programs are based, they all provide an incentive that is designed to encourage customers to conduct business preferentially with one organization rather than with competitor organizations. For example, credit card processing firms such as Visa and MasterCard, automobile manufacturers, rental car companies, department stores, long distance telephone companies, financial institutions and other organizations all offer a number of different programs for promoting purchases of their goods and/or services. This type of program may include discount offers for certain catalog items, based on volume of activity in an account. Similarly, such a program may take the form of a point system in which a customer is credited with a number of points for each transaction that they complete. Once a sufficient number of points have accrued, the customer can exchange a portion of those points for goods and/or services. Additionally, other promotional schemes have involved discounts on goods or services, different from those purchased in the account. For example, discount coupons have been offered for airline tickets, based on a minimum level of investment in a bank or savings and loan. Similarly, holders of Visa cards have been offered deeply discounted or free air travel based on a certain level of activity using a general purpose charge card, or have been credited with air miles based on activity in a charge card account.

The difficulty however is that such loyalty systems are limited in flexibility and are narrow in scope. As a result, there is a desire in the industry for more sophisticated loyalty-based systems that are flexible and that facilitate award of the rewards quickly. There is also a desire for a reward system that capitalizes on relationships between strategic partners in a manner that allows cross promotion of their goods and services through the implementation of a rewards program.

Accordingly, there is a need for a system that enables a marketer of goods and/or services and a general purpose transaction card provider or another similarly situated entity to offer an attractive incentive to customers to encourage the use of a general purpose transaction card. There is a further need for a system that allows a provider of goods and/or services to cross promote with the provider of the general purpose transaction card in a manner that creates increased customer loyalty and brand awareness thereby deepening the customer relationship with the two program providers.

### BRIEF SUMMARY OF THE INVENTION

In this regard, the present invention provides a general purpose transaction card that offers an attractive incentive to customers to encourage the use of a general purpose transaction card. The general purpose transaction card is offered in connection with a co-branded loyalty program whereby a percentage of a total purchase made at one vendor is deposited into an account maintained at another vendor. More specifically, in a preferred embodiment of the present invention provides for a grocery vendor to deposit a percentage of a customer's total grocery purchase into a savings account held by that customer at a bank service provider. By offering a transaction method in accordance with the teachings of the present invention both of the vendors gain in the number of joint customers while deepening the relationship those customers have with both vendors.

In operation the method of the present invention begins with the establishment of an account at the banking service provider. In addition, a customer registers a transaction card with the second vendor in the form of a customer loyalty card or by simply registering an existing electronic transaction card. Once the account and the tracking means (registered transaction card) are established, the customer then makes purchases with the goods and service vendor wherein those purchases are identified or linked to the registered electronic transaction card. The goods and services vendor then arranges for a percentage of the total cost of the purchase made to be deposited into the corresponding savings account at the bank service provider.

In determining the percentage of the purchase to be deposited with the bank service provider, various different rules may be established. For example, the goods and service provider may determine a threshold purchase that must be reached before a percentage deposit will be made. Also within the scope of the present invention, the goods and service provider may exclude certain products under the purchase threshold requirement. For example, lottery tickets, tobacco products, fuel, gift cards, pharmacy items and the like may be excluded from the program. Similarly, the may be a cap on the total amount of deposits made. Similarly, the bank service provider may structure the transaction such that a larger percentage deposit is made based on the level of banking services that the customer uses at the bank. For example, a standard customer may get a 1% deposit, a preferred customer may get a 2% deposit while an elite customer may get a 3% deposit.

In processing a transaction in accordance with the method of the present invention, a listing of customers enrolled in the incentive/reward program is compiled wherein the listing identifies the customer, the registered electronic transaction card and the customer banking account. A processor then matches the purchases that were made and linked with the registered electronic transaction card with the customer and the customer's bank account. Periodically, the purchase history as matched with the customer is provided to the bank service provider and makes a deposit into the customer's account based on the previously established rules.

It is therefore an object of the present invention to provide a system that enables a marketer of goods and/or services and a general purpose transaction card provider or another similarly situated entity to offer an attractive incentive to customers to encourage the use of a general purpose transaction card. It is a further object of the present invention to provide a system that allows a provider of goods and/or services to cross promote with the provider of the general purpose transaction card in a manner that creates increased customer loyalty and brand awareness thereby deepening the customer relationship with the two program providers.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a schematic diagram illustrating a first embodiment of the method and system of the present invention; and

FIG. 2 is a schematic diagram illustrating a second embodiment of the method and system of the present invention.

### DETAILED DESCRIPTION OF THE INVENTION

Now referring to the drawings, the method and system of the present invention is shown and generally illustrated in the figures. As can be seen the present invention is generally a co-branded loyalty program whereby a percentage of a total purchase made at one vendor is deposited into an account maintained at another vendor. More specifically, in a preferred embodiment of the present invention provides for a grocery vendor to deposit a percentage of a customer's total grocery purchase into a savings account held by that customer at a bank service provider. By offering a transaction method in accordance with the teachings of the present invention both of the vendors gain in the number of joint customers while deepening the relationship those customers have with both vendors.

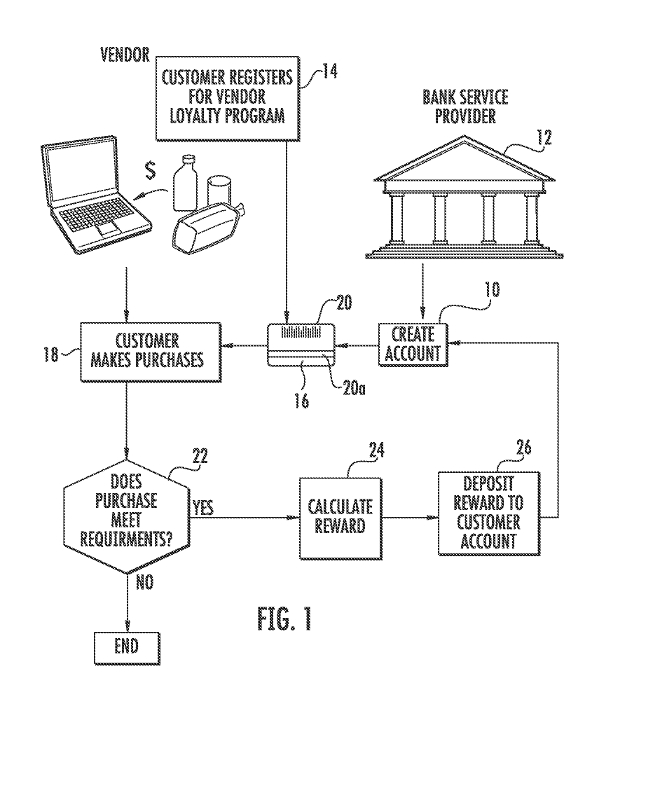

As can be seen at FIG. 1, the operation of most general embodiment of the present invention begins with the establishment of an account 10 at the banking service provider 12 for the benefit of a customer. In addition, the customer registers for a loyalty program 14 with a second vendor, wherein the loyalty program 14 is linked to a customer loyalty card 16, a new electronic transaction card or an existing electronic transaction card. In this manner, as purchases are made at the second vendor in connection with the loyalty/transaction card 16 the card serves as tracking means for all purchases made in connection with the card 16. Once the account 10 and the tracking means are established, the customer then makes purchases 18 with the goods and service vendor wherein those purchases 18 are identified or linked to the registered electronic transaction card 16. The goods and services vendor then arranges for a percentage of the total cost of the purchases tracked to be deposited into the corresponding account 10 at the bank service provider 12.

In this context, the account 10 employed in connection with the present invention may be a savings account or any other suitable type of account including but not limited to money market accounts, checking accounts, debit accounts, etc. Similarly, a loyalty/transaction card 16 is provided that is preferably a transaction card that includes machine readable indicia 20 thereon to facilitate use as a loyalty card 20. In one embodiment, the card 16 may simply be a loyalty card with indicia thereon that assists the second vendor in tracking the purchases made by the customer. In another embodiment, the card has indicia 20 that serves both to allow the second vendor to track the customer's purchases as well as indicia 20a that allows the card 16 to function as a traditional electronic transaction card such that the card 16 allows access to a cash balance that resides on the card 16 itself or in an account that is tied to the card 16. Such machine readable indicia 20 may be in the form of a magnetic strip or may be recorded in an account to which access is gained via a code on a magnetic strip or a code that is readable via an optical scanner. Still further, it is preferable that the transaction card 10 includes first machine readable indicia thereon relating to the available fund balance the transaction card and second machine readable indicia thereon relating to a loyalty reward program tied to the usage of the transaction card. It should be appreciated by one skilled in the art that while reference is made to first and second machine readable indicia such indicia may combined into a single code or magnetic strip on the transaction card or may be provided as separate codes or magnetic strips.

In determining the percentage of the purchase 18 to be deposited with the bank service provider 12, various different rules may be established. For example, the goods and service provider may determine a threshold purchase that must be reached before a percentage deposit will be made. Also within the scope of the present invention, the goods and service provider may exclude certain products under the purchase threshold requirement. For example, lottery tickets, tobacco products, fuel, gift cards, pharmacy items and the like may be excluded from the program. Similarly, there may be a cap on the total amount of deposits made. In addition to restrictions imposed by the vendor, the bank service provider may structure the transaction such that a larger percentage deposit is made based on the level of banking services that the customer uses at the bank. For example, a standard customer may get a 1% deposit, a preferred customer may get a 2% deposit while an elite customer may get a 3% deposit.

Accordingly, a determination is made as to whether the purchase 18 meets the requirements 22 set forth by the vendor. If the purchase 18 does not meet those requirements 22, no further action is taken. However, if the purchase 18 meets the requirements 22, then the reward amount 24 is calculated in accordance with the rules established and the reward amount 24 is deposited 26 into the customer account 10.

To facilitate processing a transaction in accordance with the method of the present invention, a listing of customers enrolled in the incentive/reward program is compiled wherein the listing identifies the customer, the registered electronic transaction card and the corresponding customer banking account. The purchases are tracked relating to the transaction card. In one embodiment, a third party processor matches the purchases that were made and linked with the registered electronic transaction card with the customer and the customer's bank account. Periodically, the purchase history as matched with the customer is provided to the bank service provider and a deposit is made into the customer's account based on the previously established rules.

In one illustrative embodiment, an incentive program is provided as a co-branded loyalty program between a bank service provider and a grocery vendor. The program is established to reward customers by depositing a percentage of their total grocery purchases into their savings account. To qualify, customers must have a grocery loyalty card and am account at the bank service provider. Customers receive a credit for every grocery purchase of $50 or more on eligible purchases wherein the credit is based on the type of account they have. Customers having a basic account receive 1% back for all purchases of $50 or more, customers having a premium account receive 2% back for all purchases of $50 or more and customers having an elite account receive 3% back for all purchases of $50 or more. Eligible purchases include all grocery purchases excluding gift cards, money orders, Western Union, postage stamps, lottery tickets, alcoholic beverages, tobacco products, pharmacy items, fuel, and any other purchases prohibited by law and the maximum amount of earnings per customer is $599.

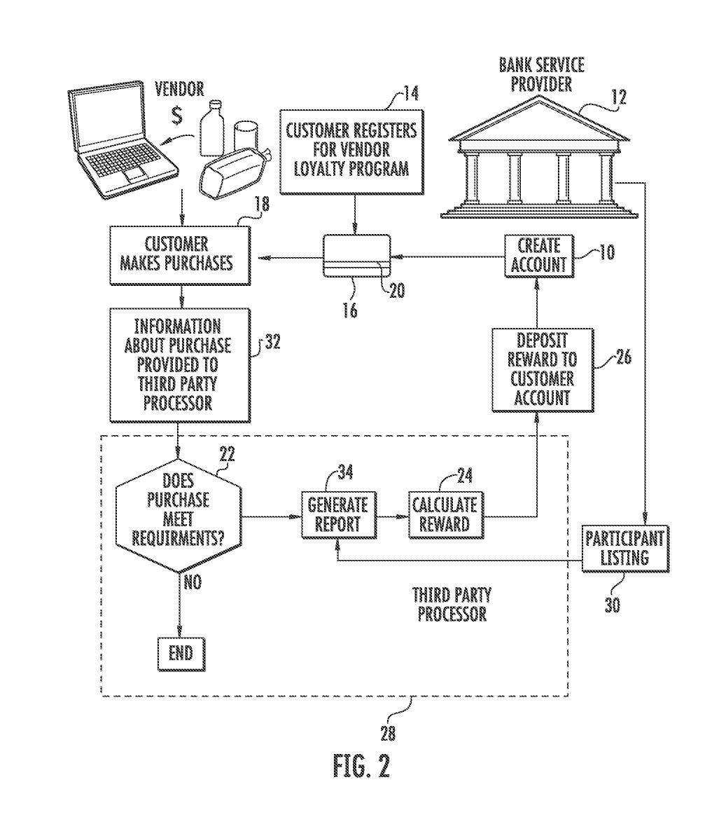

In an alternate embodiment as provided at FIG. 2, a third party processor 28 holds and processes all of the data relating to the program. Periodically, the bank service provider 12 creates a listing 30 that includes all customers that have enrolled in the program and transfers the file to the third party processor 28. The file contains the enrollment ID, first name, last name, email, checking and statement savings account numbers, grocery vendor loyalty card number and enrollment date. The processor 28 then matches daily purchase transaction data 32 provided by the grocery vendor to the bank service provider listing in a manner that reports 34 all eligible purchases and calculates the corresponding periodic reward amount 24 for each customer. The bank service provider then makes the required deposit into the customer's account.

It can therefore be seen that the present invention provides a system that enables a marketer of goods and/or services and a general purpose transaction card provider or another similarly situated entity to offer an attractive incentive to customers to encourage the use of a general purpose transaction card whereby a provider of goods and/or services can cross promote with the provider of the general purpose transaction card in a manner that creates increased customer loyalty and brand awareness thereby deepening the customer relationship with the two program providers. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of conducting a transaction to provide a customer with a loyalty incentive comprising:
identifying a customer account at a bank service provider;
linking a vendor loyal program in which the customer participates with the account;
tracking purchases made by a customer within the vendor loyalty program;
calculating an incentive amount based on the purchases tracked; and
depositing the incentive amount to the customer account.

2. The method of claim 1, wherein the customer account is an existing account.

3. The method of claim 1, wherein the customer account is a newly established account.

4. The method of claim 1, wherein the customer account is selected from the group consisting of: savings accounts, money market accounts, checking accounts and debit accounts.

5. The method of claim 1, wherein said step of calculating an incentive amount based on the purchases tracked is completed by a third party.

6. A method of conducting a transaction to provide a customer with a loyalty incentive comprising:
identifying a customer account at a bank service provider;
linking a vendor loyal program in which the customer participates with the account;
presenting a card bearing indicia to said vendor, said indicia being linked to the customer's participation in the vendor loyalty program, said indicia allowing said vendor to track purchases made by the customer;
calculating an incentive amount based on the purchases tracked; and
depositing the incentive amount to the customer account.

7. The method of claim 6, said card also including indicia identifying said customer account.

8. The method of claim 6, wherein said card includes a first set of indicia relating to said loyalty program and a second set of indicia relating to said customer account.

9. The method of claim 8, wherein said first and second indicia appear separately on said card.

10. The method of claim 8, wherein said first and second indicia appear jointly on said card.

11. The method of claim 6, wherein the customer account is an existing account.

12. The method of claim 6, wherein the customer account is a newly established account.

13. The method of claim 6, wherein the customer account is selected from the group consisting of: savings accounts, money market accounts, checking accounts and debit accounts.

14. The method of claim 6, wherein said step of calculating an incentive amount based on the purchases tracked is completed by a third party.

15. A method of conducting a transaction to provide a customer with a loyalty incentive comprising:
identifying a customer account at a bank service provider;
linking a grocery loyal program in which the customer participates with the account;
presenting a card bearing indicia to a grocery vendor, said indicia being linked to the customer's participation in the grocery loyalty program, said indicia allowing said grocery vendor to track purchases made by the customer;
calculating an incentive amount based on the purchases tracked; and
depositing the incentive amount to the customer account.

16. The method of claim 15, said card also including indicia identifying said customer account.

17. The method of claim 15, wherein said card includes a first set of indicia relating to said loyalty program and a second set of indicia relating to said customer account.

18. The method of claim 17, wherein said first and second indicia appear separately on said card.

19. The method of claim 17, wherein said first and second indicia appear jointly on said card.

20. The method of claim 15, wherein the customer account is an existing account.

21. The method of claim 15, wherein the customer account is a newly established account.

22. The method of claim 15, wherein the customer account is selected from the group consisting of: savings accounts, money market accounts, checking accounts and debit accounts.

23. The method of claim 15, wherein said step of calculating an incentive amount based on the purchases tracked is completed by a third party.
